(19) United States
(12) Patent Application Publication
(10) Pub. No.: US 2018/0326827 A1
(43) Pub. Date: Nov. 15, 2018

(54) STRUCTURAL ROOF PANEL FOR VEHICLE

(71) Applicant: FORD GLOBAL TECHNOLOGIES, LLC, Dearborn, MI (US)

(72) Inventors: Kyle Otremba, Farmington Hills, MI (US); Matthew B. Rutman, Canton, MI (US)

(21) Appl. No.: 15/592,370

(22) Filed: May 11, 2017

(51) Int. Cl. B60J 7/16; B60J 7/19; B60J 10/90

(52) U.S. Cl. CPC B60J 7/1642; B60J 10/90; B60J 7/194

(57) ABSTRACT

A T-top roof assembly for a vehicle includes a roof member defining at least one vehicle-inboard insert edge receiver and at least one removable insert having an insert receiver-engaging edge and an opposed stiffener edge. A latch mechanism is included, adapted to secure the opposed stiffener edge to the roof member. The opposed stiffener edge includes a structural load path-supporting member. The latch mechanism comprises at least one spring-loaded pin, clip, bolt, or rotary latch and a cooperating latch receiver or striker, variously carried by the opposed stiffener edge and the roof member.

### TECHNICAL FIELD

The present disclosure generally relates to roofs for vehicles. More specifically, the present disclosure relates to a T-top style roof assembly including easily removable panels that when installed provide structural load paths for the vehicle roof.

### BACKGROUND

Various vehicles are known which provide an “open air” feel to the occupants. Examples include convertibles, wherein most if not all of the roof member is configured for folding and storing. Another example is a vehicle including a so-called “T-top” or hatch style roof member. As is known, the T-top roof includes removable panels which may be easily removed and replaced as desired by the vehicle occupant. The T-top roof may further include a central support which provides structural integrity to the roof member and also may assist in supporting the edges of the removable panels.

Disadvantageously, the removable panels replace portions of the roof member which, in a roof lacking such removable panels, would provide structural load paths and contribute to the structural rigidity of the roof. Conventional replaceable panels for T-top roof assemblies, which for convenience must be easily removed and replaced without tools or use of fixed fasteners such as bolts, cannot supply such structural load paths/structural rigidity. Instead, such conventional panels merely serve as a cover to protect the vehicle interior from environmental factors such as rain, wind, etc. Accordingly, there is identified a need in the art for T-top roof assemblies which overcome the above-listed disadvantages.

### SUMMARY

In accordance with the purposes and benefits described herein, in one aspect of the present disclosure a T-top roof assembly for a vehicle is provided, comprising a roof member defining at least one vehicle-inboard insert edge receiver and at least one removable insert having an insert receiver-engaging edge and an opposed stiffener edge. The opposed stiffener edge may include a structural load path-supporting member.

A latch mechanism is also provided, adapted to secure the opposed stiffener edge to a vehicle element. The roof member may further include an insert-supporting flange. A sealing member may be provided to prevent water intrusion, carried by the insert-supporting flange and insert receiver. In embodiments, the insert-supporting flange defines a curl flange carrying the sealing member.

In embodiments, the latch mechanism comprises at least one spring-loaded pin, clip, or bolt carried by the opposed stiffener edge and a vehicle-outboard latch receiver carried by the roof member. In alternative embodiments, the latch mechanism comprises at least one rotary latch carried by the opposed stiffener edge and a striker carried by the roof member. In still other alternative embodiments, the latch mechanism comprises at least one spring-loaded pin, clip, or bolt carried by the roof member and a vehicle-outboard latch receiver carried by the opposed stiffener edge.

In embodiments, the insert receiver-engaging edge comprises at least one pair of insert receiver-engaging fingers. In alternative embodiments, the insert receiver-engaging edge comprises an insert receiver-engaging groove.

In the following description, there are shown and described embodiments of the disclosed T-top roof assembly. As it should be realized, the described devices are capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed T-top roof assembly, and together with the description serve to explain certain principles thereof. In the drawings:

FIG. 1 shows a vehicle including a T-top roof according to the present disclosure;

FIG. 2A shows a side perspective view of a cutout portion of the T-top roof of FIG. 1;

FIG. 2B shows a vehicle-rear view of a removable insert being secured to the cutout portion of FIG. 2A;

FIG. 2C shows a sectional view of an insert-supporting flange of the cutout portion of the T-top roof of FIG. 1;

FIG. 3A shows an isolated view of an embodiment of a removable insert receiver-engaging edge engaging a vehicle-inboard receiver;

FIG. 3B shows an alternative embodiment of the removable insert receiver-engaging edge of FIG. 3A;

FIG. 3C shows an isolated view of another alternative embodiment of a removable insert receiver-engaging edge engaging a vehicle-inboard receiver;

FIG. 4A shows a bottom perspective view of a removable insert stiffener edge and latch mechanism;

FIG. 4B shows a side view of an alternative embodiment of a removable insert stiffener edge and latch mechanism;

FIG. 5A shows in side view an alternative embodiment of a latch mechanism for use with a T-top roof assembly according to the present disclosure;

FIG. 5B shows in side view another alternative embodiment of a latch mechanism for use with a T-top roof assembly according to the present disclosure;

FIG. 6A shows in side cross-sectional view an embodiment of an embodiment of an interior stiffening member for a removable insert according to the present disclosure; and

FIG. 6B shows in side cross-sectional view an alternative embodiment of the interior stiffening member of FIG. 6A.

Reference will now be made in detail to embodiments of the disclosed T-top roof assembly, examples of which are illustrated in the accompanying drawing figures.

### DETAILED DESCRIPTION

Preliminarily, certain features of the disclosed T-top roof assembly are described using locator terminology such as “vehicle-inboard” and “vehicle-outboard.” As is known, such terms relate to the location of a feature relative to a vehicle central longitudinal axis (x-axis). So, a feature that is described as vehicle-inboard or vehicle-outboard will be understood to be closer to or farther from, respectively, the vehicle central longitudinal axis. Likewise, a feature described as vehicle-inboard or vehicle-outboard of another feature will be understood to be farther from or closer to or farther from the vehicle central longitudinal axis, respectively, relative to the other feature.

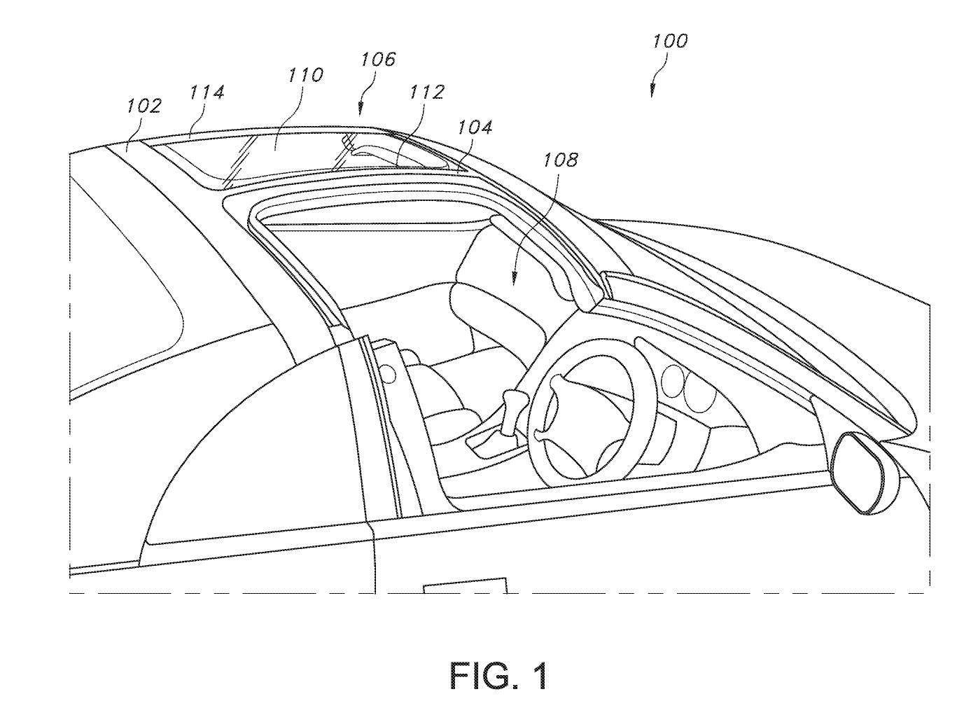

FIG. 1 illustrates a vehicle 100 including a T-top roof assembly according to the present disclosure. The vehicle 100 includes a roof panel 102 which includes a pair of cutout portions separated by a central spine member 104. The cutout portions are dimensioned to receive a pair of removable inserts 106 (only one insert shown), which may be removed by the vehicle 100 occupant to provide a desired “open air” feel and restored to close off the vehicle passenger cabin 108. The removable inserts 106 are defined by a panel 110 having an insert receiver-engaging edge 112 and an opposed stiffener edge 114. The stiffener edge 114 may include an interior stiffening member 142 (not visible in this view) such as a tube or beam. In the depicted embodiment, the panel 110 is fabricated of a translucent/transparent material such as safety glass to function as a de facto moon roof, although equally the panel could be opaque and fabricated of metal, polymers, fiberglass, and combinations.

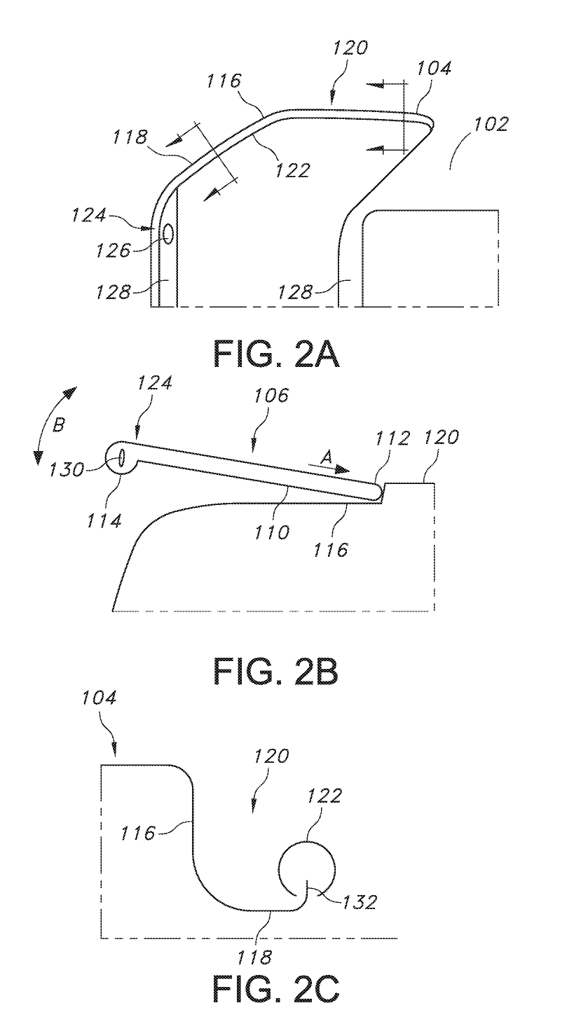

FIG. 2A shows a side perspective view of a cutout portion of the T-top roof panel 102. The cutout portion includes an edge 116 having an insert-supporting flange 118 on which the installed removable insert 106 (not shown in this view) rests. The vehicle-inboard central spine member 104 includes a receiver 120 for the insert receiver-engaging edge 112, which will be discussed in further detail below. A sealing member 122 may also be provided, to prevent or reduce rattle, wind noise, and intrusion of wind and/or water into the passenger cabin 108. As will be appreciated, the biasing force imposed by the sealing member 122 aids in keeping the installed removable insert 106 firmly in place.

There is further provided a latch mechanism 124 comprising a first portion 126 carried by a vehicle element 128 and a second portion 130 (not shown in this view) carried by the insert opposed stiffener edge 114. In the depicted embodiment, the latch mechanism 124 includes a pair of first portions 126 (only one visible in this view) each carried by a vehicle pillar structure 128. However, it will be appreciated that a single first portion 126 could be provided, carried by a vehicle pillar 128 or other vehicle element. As shown in FIG. 2B, to secure the removable insert 106, a user advances the removable insert (arrow A) to engage the vehicle-inboard receiver 120 by the insert receiver-engaging edge 112, and rotates the removable insert downwardly (arrow B) to latch the removable insert via the latch mechanism 124.

The insert-supporting flange 118 may optionally further include a curl flange 132 which carries the sealing member 122 (see FIG. 2C). As will be appreciated, the curl flange 132, in concert with the sealing member 122, helps prevent water intrusion into the passenger cabin 108 by channeling water away.

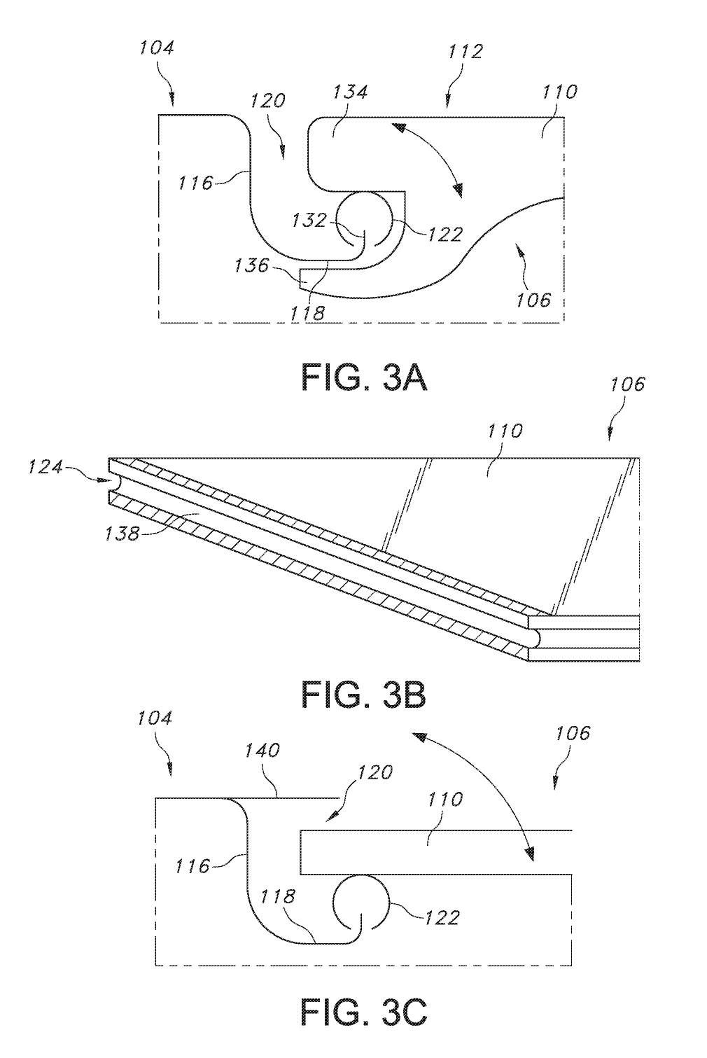

Various embodiments are contemplated for the insert receiver-engaging edge 112 and receiver 120. With reference to FIGS. 3A-C, in one embodiment (see FIG. 3A), the receiver 120 may be as shown in FIG. 2 C and the insert receiver-engaging edge 112 may include one or more pairs of fingers 134, 136 configured to engage the insert-supporting flange 118, curl flange 132 (if present), and sealing member 122. In an alternative embodiment (see FIG. 3B), the insert receiver-engaging edge 112 may include or define a groove 138 configured to engage the insert-supporting flange 118, curl flange 132 (if present), and sealing member 122 (not shown in this view). In still another embodiment, the vehicle-inboard central spine member 104 may include or define a lip 140 which, in conjunction with the edge 116, insert-supporting flange 118, curl flange 132 (if present), and sealing member 122 define the receiver 120 for a substantially planar edge of a panel 110.

Likewise, various embodiments are contemplated for the latch mechanism 124. As discussed above, the removable inserts 106 are each defined by a panel 110 having an insert receiver-engaging edge 112 (not visible in this view) and an opposed stiffener edge 114. The stiffener edge 114 may include an interior stiffening member 142 such as a tube or beam.

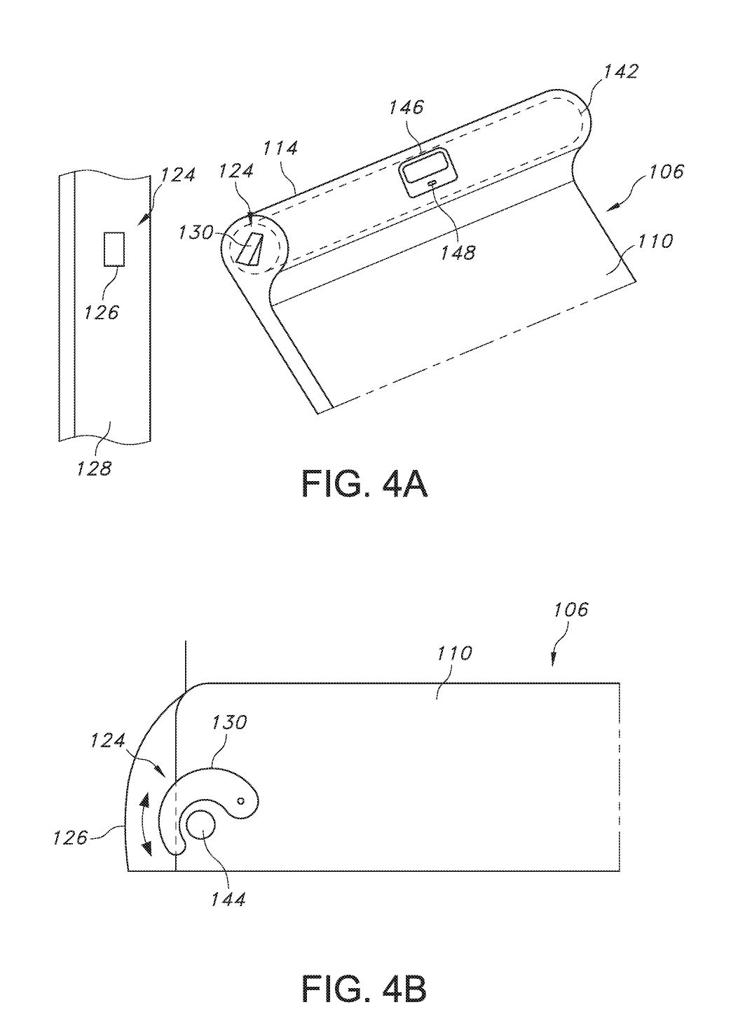

With reference to FIGS. 4A-B, in an embodiment it is contemplated to define the latch mechanism 124 by a first portion 126 defining a receiver on, e.g., a vehicle element such as a vehicle pillar 128 (see also FIG. 2A) and a second portion 130 provided as a latch disposed on one or both ends of the stiffener edge 114. The latch may be a spring-loaded clip, bolt, pin, or other suitable latch as is known in the art. It will be understood that the first portion 126 will be dimensioned and configured accordingly to receive the particular type of latch selected. In an alternative embodiment, with reference to FIG. 4B a latch mechanism 124 may be provided comprising a second portion 130 configured as a spring-loaded rotary latch of known design, adapted to selectively rotate to capture/release a pin or rod 144 acting as a striker and disposed within an interior of the first portion 126. The above-described mechanisms may be actuated by a release handle 146 adapted to retract or release each second portion 130 to respectively release or engage each first portion 126 as needed. A lock mechanism 148 may also be provided for added security.

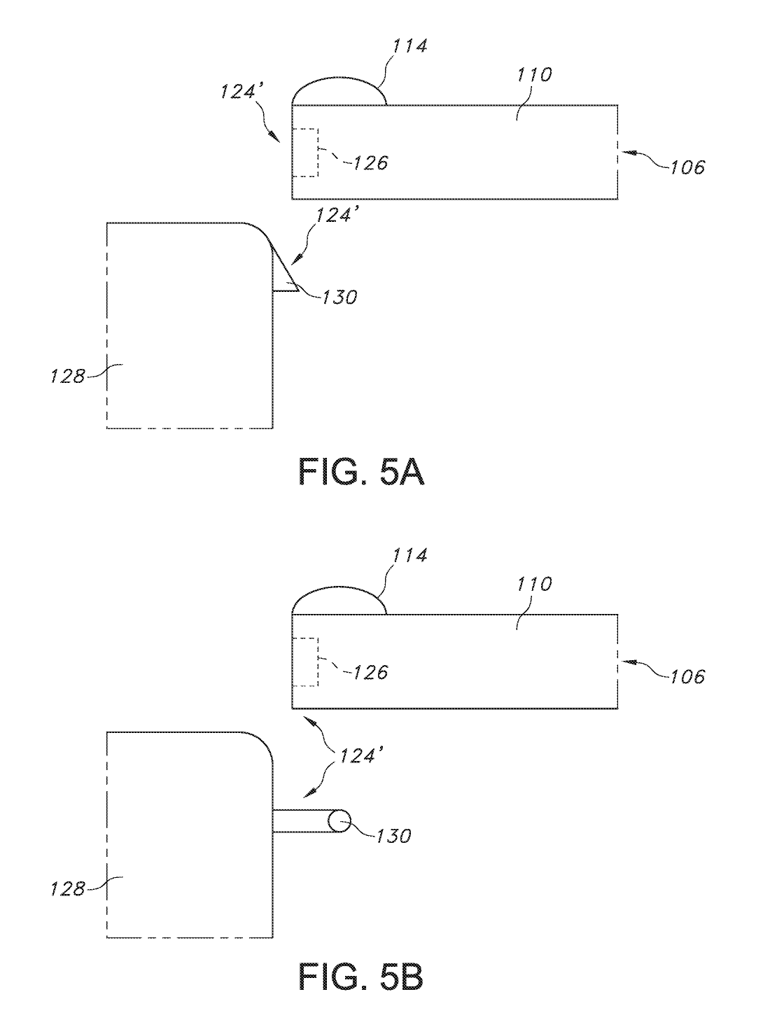

In still other embodiments, the position of the first portion 126 and the second portion 130 of the latch mechanism 124 may be reversed from the embodiments described above. That is, the first portion 126 may be disposed on the removable insert stiffener edge 114, and the second portion 130 may be disposed on the vehicle element, for example a pillar 128. This is illustrated in FIGS. 5A-B showing a latch mechanism 124′ defined by a first portion 126 defining a receiver on one or both ends of the stiffener edge 114, the receiver being dimensioned and configured accordingly to receive the particular type of second portion 130 selected. The latch mechanism 124′ further includes a second portion 130 defining a latch and carried by a vehicle element such as a vehicle pillar 128. As described above, the second portion 130 may be a spring-loaded clip, bolt, pin, or other suitable latch as is known in the art. In the embodiment shown in FIG. 5B, the second portion 130 may be configured as a translatable bolt such as are currently used on vehicle side doors, providing increased structural rigidity to the roof panel 102 when the removable insert 106 is installed.

As will be appreciated, the above-described latch mechanisms 124 as shown in FIGS. 4A-B are operated by the user by manually actuating, e.g. the release handle 146 disposed on the stiffener edge 114 or other portion of the releasable insert 106. Such manual actuation is likewise contemplated for the latch mechanism 124′ embodiments shown in FIGS. 5A-B, such as by disposing manual actuators such as pushbuttons or other actuators (embodiment not shown) for actuating the second portions 130 on a portion of the vehicle 100 such as a pillar 128. On the other hand, the above-described latch mechanism 124′ as shown in FIGS. 5A-B, by positioning the second (translatable) portion 130 in association with a vehicle element such as a pillar 128, conveniently admits of a centralized actuation of the latch mechanism. This could be accomplished by way of an existing automated door latching/locking system (not shown), the details of which are well-known in the art.

As will also be appreciated, the described removable inserts 106 including a stiffening edge 114 serve a further function of providing a structural load path for the roof panel 102 when the removable inserts 106 are installed as described above. By such structural load paths provided by the installed removable inserts 106, structural rigidity of the roof panel 102 is maintained and improved. In turn, these features of improving structural rigidity/providing structural load paths are provided by removable panels that can be easily and conveniently removed or replaced without use of tools or need for fixed fasteners such as bolts, screws, or the like.

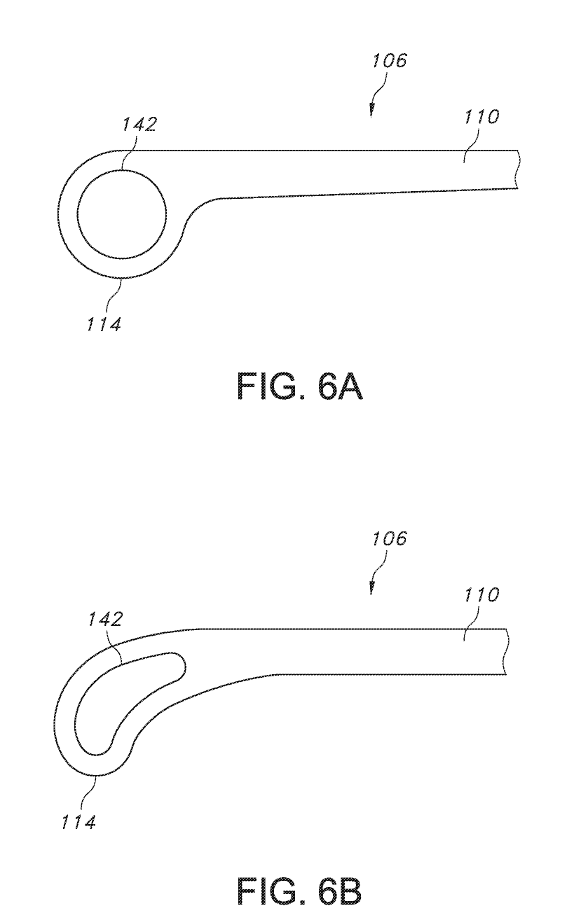

Obvious modifications and variations are possible in light of the above teachings. For example, as shown in FIG. 6A the interior stiffening member 142 for the stiffener edge 114 may define a circle in cross-section. However, it is further contemplated to provide interior stiffening members 142 defining alternative shapes in cross-section, to likewise provide a cross-sectional shape for the stiffener edge 114 suitable to the packaging space available for the removable insert 106, and/or which provides a removable insert which conforms to the side contour of the vehicle 100 to which the removable insert is attached. In the embodiment of FIG. 6B, the interior stiffening member 142 defines a substantially crescent-shaped cross-section. However, any suitable shape is contemplated.

All such modifications and variations are within the scope of the appended claims when interpreted in accordance with the breadth to which they are fairly, legally and equitably entitled.

1. A T-top roof assembly for a vehicle; comprising:
a roof member defining at least one vehicle-inboard insert receiver;
at least one removable insert having an insert receiver-engaging edge and an opposed stiffener edge;
a structural load path-supporting member carried within the opposed stiffener edge; and
a latch mechanism adapted to secure the opposed stiffener edge to a vehicle element.

2. The T-top roof assembly of claim 1, wherein the roof member further includes an insert-supporting flange.

3. The T-top roof assembly of claim 2, wherein the insert-supporting flange and insert receiver include a sealing member.

4. The T-top roof assembly of claim 3, wherein the insert-supporting flange defines a curl flange carrying the sealing member.

5. The T-top roof assembly of claim 1, wherein the latch mechanism comprises at least one spring-loaded pin, clip, or bolt carried by the opposed stiffener edge and a vehicle-outboard latch receiver carried by the vehicle element.

6. The T-top roof assembly of claim 1, wherein the latch mechanism comprises at least one rotary latch carried by the opposed stiffener edge and a striker carried by the vehicle element.

7. The T-top roof assembly of claim 1, wherein the latch mechanism comprises at least one spring-loaded pin, clip, or bolt carried by the vehicle element and a vehicle-outboard latch receiver carried by the opposed stiffener edge.

8. The T-top roof assembly of claim 1, wherein the insert receiver-engaging edge comprises at least one pair of insert receiver-engaging fingers.

9. The T-top roof assembly of claim 1, wherein the insert receiver-engaging edge comprises an insert receiver-engaging groove.

10. (canceled)

11. A T-top roof assembly for a vehicle; comprising:
a roof member defining at least one vehicle-inboard insert receiver;
a vehicle element including a vehicle-outboard latch receiver or striker;
at least one removable insert having an insert receiver-engaging edge and an opposed stiffener edge including at least one spring-loaded pin, clip, bolt, or rotary latch; and
a structural load path-supporting member carried within the opposed stiffener edge.

12. The T-top roof assembly of claim 11, wherein the roof member further includes an insert-supporting flange.

13. The T-top roof assembly of claim 12, wherein the insert-supporting flange and insert receiver include a sealing member.

14. The T-top roof assembly of claim 11, wherein the insert receiver-engaging edge comprises at least one pair of insert receiver-engaging fingers.

15. The T-top roof assembly of claim 11, wherein the insert receiver-engaging edge comprises an insert receiver-engaging groove.

16. A T-top roof assembly for a vehicle; comprising:
a roof member defining at least one vehicle-inboard insert receiver;
a vehicle element including at least one spring-loaded pin, clip, bolt, or rotary latch; and
at least one removable insert having an insert receiver-engaging edge and an opposed stiffener edge including a latch receiver or striker; and
a structural load path-supporting member carried within the opposed stiffener edge.

17. The T-top roof assembly of claim 16, wherein the roof member further includes an insert-supporting flange.

18. The T-top roof assembly of claim 17, wherein the insert-supporting flange and insert receiver include a sealing member.

19. The T-top roof assembly of claim 16, wherein the insert receiver-engaging edge comprises at least one pair of insert receiver-engaging fingers.

20. The T-top roof assembly of claim 16, wherein the insert receiver-engaging edge comprises an insert receiver-engaging groove.
